(19) United States
(12) Patent Application Publication
(10) Pub. No.: US 2025/0079094 A1
(43) Pub. Date: Mar. 6, 2025

(54) MOVABLE CONTACT DRIVING DEVICE AND SWITCHING APPARATUS

(71) Applicant: Schneider Electric Industries SAS, Rueil-Malmaison (FR)

(72) Inventor: Xuedong Xia, Shanghai (CN)

(73) Assignee: Schneider Electric Industries SAS, Rueil-Malmaison (FR)

(21) Appl. No.: 18/575,576

(22) PCT Filed: Nov. 3, 2023
(86) PCT No.: PCT/CN2023/129582

§ 371 Date: Dec. 29, 2023

(30) Foreign Application Priority Data
Nov. 4, 2022 (CN) 202211375637X

(51) Int. Cl. H01H 3/28; H01H 50/32; H01H 71/24

(52) U.S. Cl. CPC H01H 3/28; H01H 50/32; H01H 71/24

(57) ABSTRACT

The present disclosure relates to a movable contact driving device and a switching apparatus. The movable contact driving device comprises: a contact carrier (10), an electromagnetic actuator (20) and a driving member (30). The driving member (30) is configured to, when the push rod (26) moves to a first predetermined position along the longitudinal axis, rotate relative to the push rod (26) in a first direction such that the driving member (30) engages a fixed portion of the electromagnetic actuator (20) to lock the contact carrier (10) in a position corresponding to a closed position of the movable contact (40); and, when the push rod (26) moves to a second predetermined position along the longitudinal axis, rotate relative to the push rod (26) in a second direction opposite the first direction such that the driving member (30) is unlocked from the fixed portion of the electromagnetic actuator (20) to allow the contact carrier (10) to move to a position corresponding to an open position of the movable contact (40).

The present application claims a priority right to the Chinese patent application No. 202211375637.X entitled “Movable Contact Driving Device and Switching Apparatus” filed with the Chinese Patent Office on Nov. 4, 2022, the entire disclosure of which is hereby incorporated by reference in its entirety.

### FIELD

Embodiments of the present disclosure generally relate to a switching apparatus, and particularly to a movable contact driving device for the switching apparatus.

### BACKGROUND

Switching apparatus, such as circuit breakers, are typically provided with a movable contact mechanism for driving the movable contact to move, to drive the movable contact to selectively engage with or disengage from a stationary contact of the switching apparatus, thereby setting the switching apparatus in different switching states. As an example, a conventional circuit breaker employs a link actuation mechanism to drive the movable contact to move, and such a driving mechanism is not suitable for intelligent control. It is desirable to improve the movable contact driving device of the conventional switching apparatus to facilitate intelligent control of the movable contact.

### SUMMARY

Embodiments of the present disclosure provide a movable contact driving device and a switching apparatus, intended to address one or more of the above problems and other potential problems.

According to a first aspect of the present disclosure, a movable contact driving device is provided. The movable contact driving device comprises: a contact carrier configured to carry a movable contact; an electromagnetic actuator comprising: a coil; a movable core movable along a longitudinal axis in a state in which the coil is energized; and a push rod engaged with the movable core and driven by the movable core to move along the longitudinal axis; and a driving member disposed along the longitudinal axis between the push rod and the contact carrier and configured to be driven by the push rod to drive the contact carrier along the longitudinal axis, wherein the driving member is configured to, when the push rod moves to a first predetermined position along the longitudinal axis, rotate relative to the push rod in a first direction such that the driving member engages a fixed portion of the electromagnetic actuator to lock the contact carrier in a position corresponding to a closed position of the movable contact; and, when the push rod moves to a second predetermined position along the longitudinal axis, rotate relative to the push rod in a second direction opposite the first direction such that the driving member is unlocked from the fixed portion of the electromagnetic actuator to allow the contact carrier to move to a position corresponding to an open position of the movable contact.

According to the movable contact driving device of the present disclosure, the driving member not only achieves driving of the contact carrier but also achieves locking of the movable contact at its closed position via rotation of the driving member, so that it is not necessary to maintain the locked state by energizing the coil, thereby reducing energy consumption.

In some embodiments, the electromagnetic actuator may further comprise a bobbin serving as the fixed portion and for winding the coil, the bobbin comprises a cavity extending along the longitudinal axis, and the movable core and the driving member are at least partially disposed within the cavity. Thus, the movement in the linear direction of the components arranged along the longitudinal axis can be restrained by a simple structure.

In some embodiments, one of an inner surface of the bobbin and an outer surface of the push rod may comprise a radially-protruding first guide rail, and the other of the inner surface of the bobbin and the outer surface of the push rod comprises a radially-recessed first guide groove, wherein the first guide groove cooperates with the first guide rail such that the push rod moves rectilinearly. Thereby, it can be ensured that the push rod moves rectilinearly.

In some embodiments, one of the inner surface of the bobbin and an outer surface of the driving member may comprise a radially-protruding second guide rail, and the other of the inner surface of the bobbin and the outer surface of the driving member may comprise a radially-recessed second guide groove cooperating with the second guide rail, wherein when the push rod moves to the first predetermined position along the longitudinal axis, the driving member slides rectilinearly relative to the bobbin and is rotatable relative to the push rod after the second guide rail and the second guide groove are disengaged. Thus, it is possible to ensure that the driving member moves rectilinearly within a predetermined range and is configured to rotate when being separated from the bobbin.

In some embodiments, the push rod may comprise a circumferential force-applying portion at an end face at a side facing the driving member, the circumferential force-applying portion being configured to be capable of applying a circumferential force component to the push rod to rotate the driving member. Thereby, the driving member may be conveniently driven to rotate through the movement of the push rod in the direction of the longitudinal axis.

In some embodiments, the circumferential force-applying portion may comprise a plurality of first inclined portions inclined along the longitudinal axis, the plurality of first inclined portions being circumferentially distributed on the end face of the push rod around the longitudinal axis. Thus, the circumferential force-applying portion can be implemented in a simple manner.

In some embodiments, the driving member may comprise a plurality of circumferential force-receiving portions on an end face facing the push rod which match the circumferential force-applying portions, the circumferential force-receiving portions are configured to, when the push rod moves to the first predetermined position along the longitudinal axis, interact with the circumferential force-applying portions to provide a circumferential force component for rotating the driving member in the first direction; when the push rod moves to the second predetermined position along the longitudinal axis, interact with the circumferential force-applying portions to provide a circumferential force component for rotating the driving member in the second direction. In this way, the driving member may be driven to rotate with a simple structure.

In some embodiments, the bobbin may further comprise a circumferential locking portion protruding on an inner surface thereof, the circumferential locking portion being configured to engage with the driving member to lock the driving member and the bobbin together. Thus, locking can be achieved by virtue of the configuration of the bobbin.

In some embodiments, the circumferential locking portion may comprise a circumferential stop ramp extending obliquely in a circumferential direction and a circumferential rotation-stopping surface extending along the longitudinal axis, and the circumferential stop ramp and the circumferential rotation-stopping surface are configured to interact with the driving member at different positions in the circumferential direction. Thereby, a smooth circumferential movement and circumferential stop of the driving member can be achieved.

In some embodiments, the driving member may comprise a stop portion on an end face at a side facing the push rod, and the stop portion comprises an inclined ramp configured to engage circumferential locking portion. Thereby, the structure of the driving member may be simplified.

In some embodiments, the driving member may further comprise an open position limiting portion disposed a predetermined distance away from the stop portion along the longitudinal axis, wherein during return of the driving member towards the push rod, the open position limiting portion contacts the circumferential locking portion to prevent the driving member from continuing to move rectilinearly. Thus, the open position may be defined by the open position limiting portion.

In some embodiments, the open position limiting portion is a circumferential flange projecting radially from the driving member. Thus, the structure of the open position limiting portion may be simplified.

In some embodiments, the movable contact driving device may further comprise the return spring configured to at least engage the contact carrier, the return spring configured to return the contact carrier and/or the driving member to an initial position after the coil for moving the movable core is de-energized. Thereby, the contact carrier and/or the driving member may be enabled to automatically return by means of the return spring.

In some embodiments, the movable contact driving device may further comprise a controller which is configured to receive a switching-off and/or switching-on command, and to issue a command to energize the coil in response to the received switching-off and/or switching-on command, so that the push rod moves along the longitudinal axis. Thereby, automatic control of the movable contact driving device can be conveniently achieved.

In some embodiments, the movable contact driving device may further comprise a manual button configured to be mounted to the moving movable core and/or the push rod, wherein depression of the manual button causes the push rod to move along the longitudinal axis. Thus, manual control of the movable contact driving device can also be conveniently achieved without making any substantial changes to the structure.

According to a second aspect of the present disclosure, there is provided a switching apparatus. The switching apparatus comprises: a stationary contact; a movable contact; and the movable contact driving device according to the first aspect.

In some embodiments, the switching apparatus may be a circuit breaker, a disconnecting switch or a contactor.

### BRIEF DESCRIPTION OF THE DRAWINGS

The above and other objectives, features, and advantages of example embodiments of the present disclosure will become more apparent from the following detailed description with reference to the accompanying drawings. In the figures, several embodiments of the present disclosure are shown in an exemplary but unrestrictive manner.

FIG. 1 shows an overall schematic view of a switching apparatus according to an embodiment of the present disclosure.

FIG. 2 shows a partial cross-sectional view of a switching apparatus according to an embodiment of the present disclosure, wherein the switching apparatus is in a closed state.

FIG. 3 shows a perspective view of a bobbin of a movable contact driving device according to an embodiment of the present disclosure.

FIG. 4 shows a cross-sectional view of a bobbin of a movable contact driving device according to an embodiment of the present disclosure.

FIG. 5 shows a longitudinal sectional view of a bobbin of a movable contact driving device according to an embodiment of the present disclosure.

FIG. 6 shows a perspective view of a push rod of a movable contact driving device according to an embodiment of the present disclosure.

FIG. 7 shows a perspective view of a driving member of a movable contact driving device according to an embodiment of the present disclosure.

FIG. 8 shows a perspective view of a contact carrier of a movable contact driving device according to an embodiment of the present disclosure.

FIG. 9 shows a sectional view of a switching apparatus according to an embodiment of the present disclosure, wherein the switching apparatus is in an open state and structural details of interaction of the driving member of the movable contact driving device and the bobbin are shown.

FIG. 10 shows a sectional view of a switching apparatus from another angle according to an embodiment of the present disclosure, wherein the switching apparatus is in an open state, and structural details of the interaction of a driving member, a push rod and a bobbin of the movable contact driving device are shown.

FIG. 11 shows a sectional view of a switching apparatus from another angle according to an embodiment of the present disclosure, wherein the switching apparatus is in a closed state and structural details when the driving member and the bobbin are locked to each other are shown.

FIG. 12 shows a sectional view of a switching apparatus from another angle according to an embodiment of the present disclosure, wherein the switching apparatus is in a closed state, and structural details in a state in which the push rod of the movable contact driving device releases the locking of the driving member and the bobbin are shown.

In all figures, the same or corresponding reference numbers denote the same or corresponding parts.

### DETAILED DESCRIPTION OF EMBODIMENTS

Preferred embodiments of the present disclosure will be described as follows in greater detail with reference to the drawings. Although preferred embodiments of the present disclosure are illustrated in the drawings, it is to be understood that the present disclosure described herein can be implemented in various manners, not limited to the embodiments illustrated herein. Rather, these embodiments are provided to make the present disclosure described herein clearer and more complete and convey the scope of the present disclosure described herein completely to those skilled in the art.

As used herein, the term “comprises” and its variants are to be read as open-ended terms that mean “comprises, but is not limited to.” The term “or” is to be read as “and/or” unless the context clearly indicates otherwise. The term “based on” is to be read as “based at least in part on.” The term “one example implementation” and “an example implementation” are to be read as “at least one example implementation.” The term “another implementation” is to be read as “at least one other implementation.” The terms indicating placement or positional relationship such as “up”, “down”, “front” and “rear” are based on the orientation or positional relationship shown in the figures, and are only for the convenience in describing the principles of the present disclosure, rather than indicating or implying that the designated elements must have a particular orientation, be constructed or operated in a particular orientation, and thus should not be construed as limiting the present disclosure.

Switching apparatus such as circuit breakers are widely used in power systems. With development of technologies, switching apparatus are more and more intelligent. Solid state circuit breakers, SSMCBs, are widely used as examples of intelligent circuit breakers. The solid state circuit breaker SSMCB comprises a solid state switch for controlling the circuit to open and close and a disconnecting switch for physically disconnecting the circuit. The solid state switch may be controlled by a controller to control the opening and closing of the solid state switch, thereby enabling opening and closing of the circuit of the circuit breaker. The disconnecting switch is configured to implement physical isolation of a movable contact and a stationary contact to ensure a sufficient insulation gap between the electrical contacts. The disconnecting switch further comprises a movable contact driving device for driving the movable contact to move. A conventional disconnecting switch has a large size and does not enable intelligent control. To this end, according to an embodiment of the present disclosure, there is provided a disconnecting switch that can easily implement intelligent control and has a small size and fast mobility. Hereinafter, the switching apparatus according to an embodiment of the present disclosure will be described in detail with reference to the accompanying drawings.

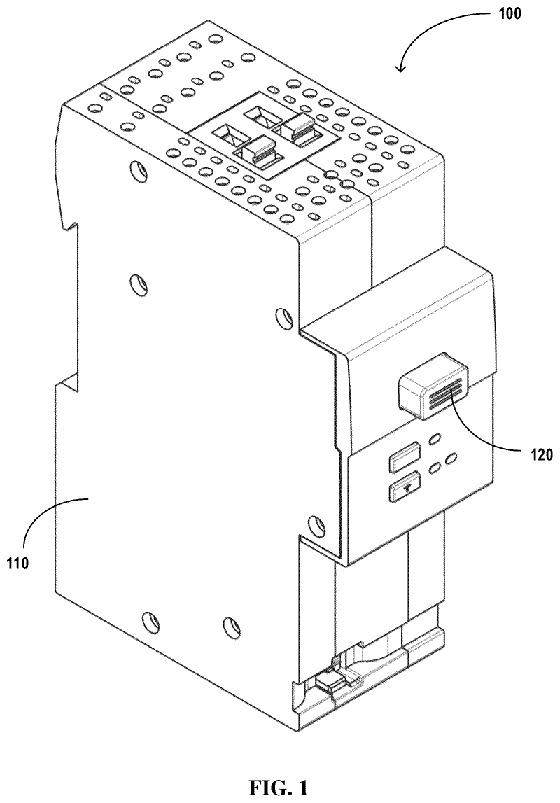

FIG. 1 shows a schematic diagram of a switching apparatus 100 according to an embodiment of the present disclosure. As shown in FIG. 1, the switching apparatus 100 comprises a housing 110 within which various electrical components of the switching apparatus 100, such as a movable contact, a stationary contact, and a driving device for driving the movable contact to move, may be disposed. In some embodiments, as shown in FIG. 1, the switching apparatus 100 may further comprise a manual button 120 which is at least partially exposed at a surface of the housing 110 and may be configured to manually move the movable contact when depressed. In this case, the switching apparatus 100 can be controlled not only intelligently but also manually to effect switching of states of the switching apparatus. In the illustrated embodiment, a circuit breaker is described as an example of the switching apparatus; it should be understood that this is merely exemplary and that the switching apparatus may also be a disconnecting switch, a contactor or any other switching apparatus comprising a movable contact driving mechanism.

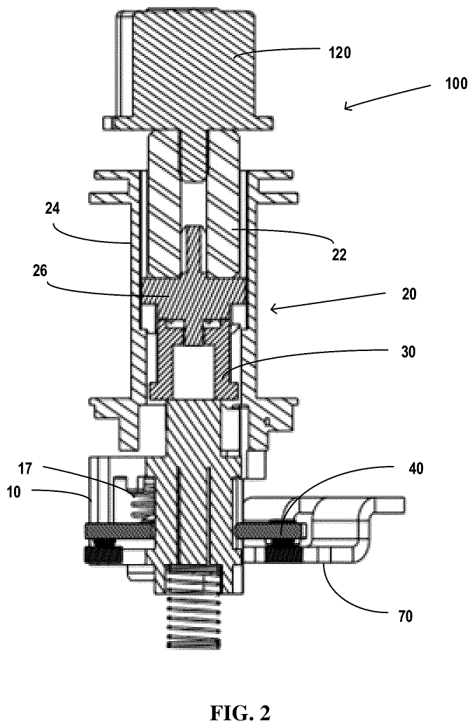

FIG. 2 shows a sectional view of a switching apparatus according to an embodiment of the present disclosure, showing main components of the movable contact driving device. It should be understood that in the illustrated embodiments, only the components of the circuit breaker relevant to the inventive concept of the present disclosure have been shown and other parts of the circuit breaker have been omitted for the sake of clarity.

As shown in FIG. 2, the movable contact driving device comprises an electromagnetic actuator 20, a driving member 30, and a contact carrier 10 arranged in sequence in an axial direction (i.e., the vertical direction in FIG. 2, also called a longitudinal direction). The contact carrier 10 is configured to carry or mount a movable contact 40. The electromagnetic actuator 20 is configured to move the driving member 30 in a longitudinal direction.

The electromagnetic actuator 20 may comprise: a bobbin 24 on which a coil is wound; a movable core 22 movable along the longitudinal axis in a state in which the coil is energized; and a push rod 26 engaged with the movable core 22 and driven by the movable core 22 to move along the longitudinal axis. When the coil is energized, the movable core 22 moves to drive the push rod 26 along the longitudinal axis.

The driving member 30 is disposed along the longitudinal axis between the push rod 26 and the contact carrier 10 and is configured to be pushed by the push rod 26 to move along the longitudinal axis. Movement of the driving member 30 along the longitudinal axis in turn drives the contact carrier 10 to move along the longitudinal axis. Since the movable contact is mounted on the contact carrier 10, the longitudinal movement of the contact carrier 10 enables switching between an open position and a closed position of the switching apparatus.

The driving member 30 may provide a locking function in addition to the function of driving the contact carrier 10. This is achieved in particular by the rotary movement of the driving member 30; the rotational movement of the driving member 30 causes the driving member 30 to engage with and disengage from a fixed member (e.g., the bobbin in some example) provided on the electromagnetic actuator 20, thereby achieving the locking of the respective switching state of the switching apparatus.

During a switching-on operation of the switching apparatus, the push rod 26 is moved along the longitudinal axis to a first predetermined position (which may correspond, for example, to the closed position), and the driving member 30 is capable of rotating relative to the push rod 26, so that the driving member 30 engages with the fixed member of the electromagnetic actuator 20 to lock the contact carrier 10 in a position corresponding to the closed position of the movable contact 40. Similarly, during a switching-off operation of the switching apparatus, the push rod 26 is moved along the longitudinal axis to a second predetermined position (which may correspond, for example, to the open position), and the driving member 30 can be unlocked from the fixed portion of the electromagnetic actuator 20. In the unlocked condition, the contact carrier 10 is allowed to move (e.g., via a return spring) to a position corresponding to the open position of the movable contact 40.

According to the movable contact driving device of the embodiment of the present disclosure, not only the automatic movement of the movable contact but also the locking of the closed state of the movable contact can be achieved by a unique movement mode of the driving member 30, whereby the movable contact can be maintained in the closing state without applying an additional maintaining current to the coil. That is, the movable contact can be automatically locked at the closing state without any further additional operation, which is beneficial for intelligence control.

Structural details of the movable contact driving device according to the embodiment of the present disclosure will be described below with reference to FIG. 3 through FIG. 8. The bobbin 24 may be fixed to an appropriate portion of the circuit breaker.

As shown in FIG. 3, the bobbin 24 comprises a cavity extending along the longitudinal axis. A moving path of the movable core 22, the push rod 26 and the driving member 30 can be restricted by an inner surface of the cavity. As shown in FIG. 3, the bobbin 24 may comprise a cylindrical structure, and an outer surface 248 of the bobbin 24 may be used for winding the coil. The inner surface of the bobbin 24 may be provided with a matching structure to achieve a position limiting and/or locking function.

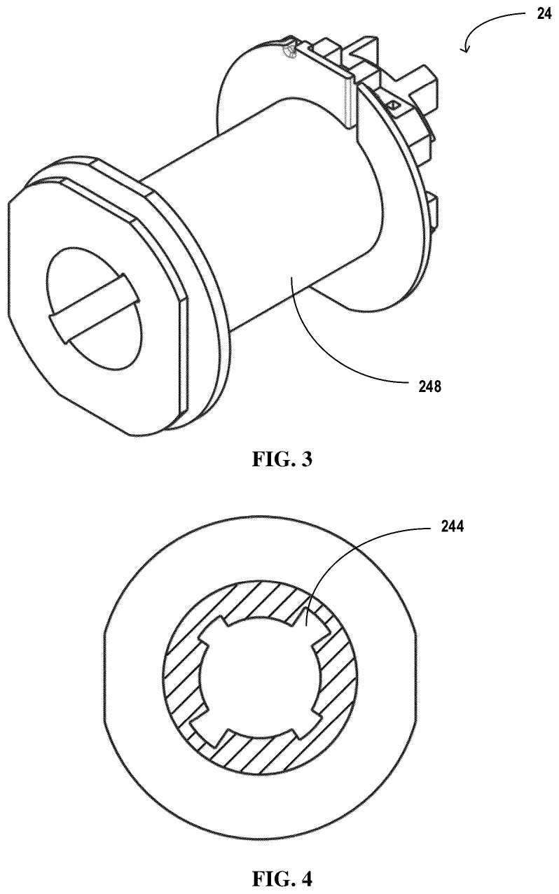

In some embodiments, the inner surface of the bobbin 24 may comprise a structure for guiding the push rod 26 to move rectilinearly. As shown in FIG. 4, the inner surface of the bobbin 24 may comprise a first guide groove 244 radially recessed from the inner surface. Referring also to FIG. 6, the outer surface of the push rod 26 may comprise a first guide rail 262 projecting radially from the outer surface of the push rod 26. As the push rod 26 moves in the longitudinal direction, it is ensured that the push rod moves rectilinearly through the matching of shapes of the first guide groove 244 and the first guide rail 262. It should be understood that the embodiments shown in FIG. 4 and FIG. 6 are merely exemplary. In other embodiments, the guide groove may be formed on the outer surface of the push rod 26 and the protruding guide rail may be formed on the inner surface of the bobbin 24.

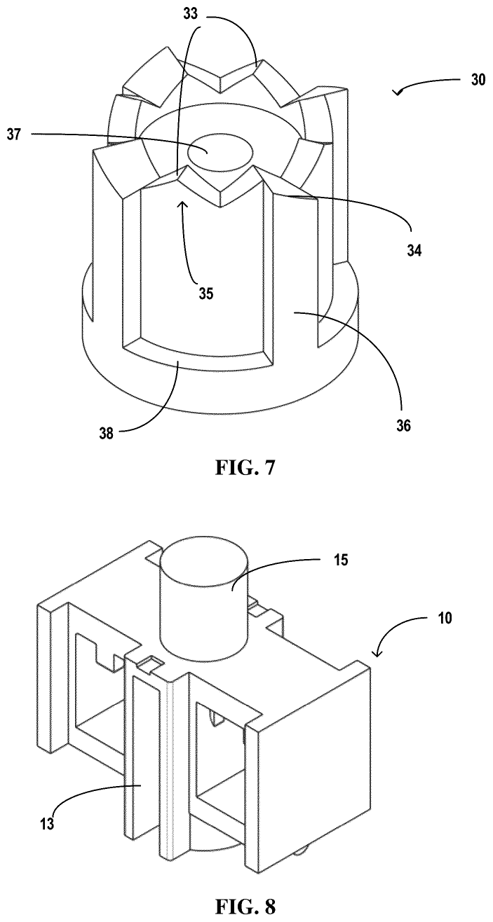

In some embodiments, the inner surface of the bobbin 24 may comprise a structure for guiding the movement of the driving member 30. A linear movement distance of the driving member 30 may be provided by the guiding structure. Furthermore, at the end of the linear movement distance, the bobbin 24 may disengage from the guiding structure to allow the driving member 30 to rotate. In some embodiments, the inner surface of the bobbin 24 may comprise a second guide groove (not shown), which may be disposed at a different position from the first guide groove in the direction of the longitudinal axis (e.g., disposed more toward the driving member 30). Referring also to FIG. 7, the outer surface of the driving member 30 may comprise a radially-projecting second guide rail 36. The second guide rail 36 may cooperate with the second guide groove to guide the driving member 30 to move rectilinearly along the longitudinal axis. During movement of the push rod 26 along the longitudinal axis, the driving member 30 may slide rectilinearly relative to the bobbin 24, and the driving member 30 is configured to rotate relative to the push rod 26 after the second guide rail 36 disengages from the second guide groove.

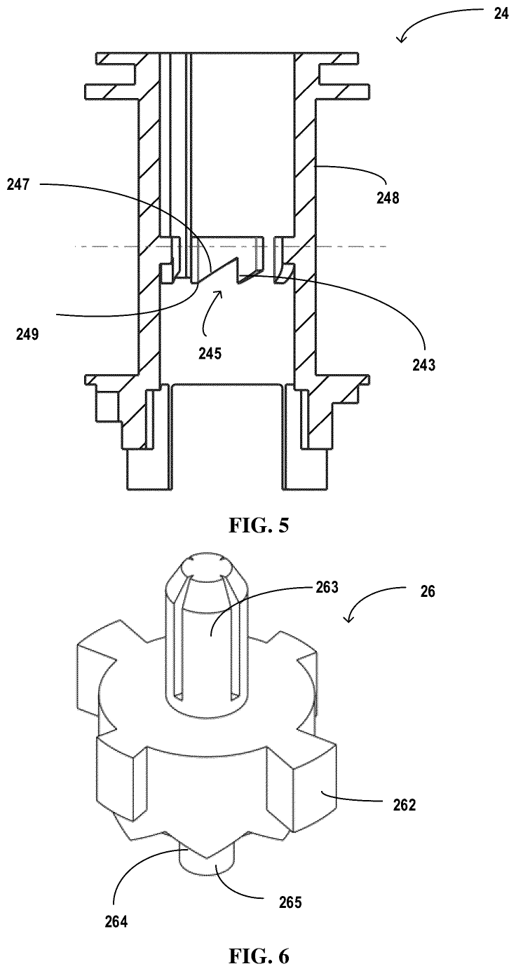

In some embodiments, as shown in FIG. 5, the bobbin 24 further comprises one or more circumferential locking portions 245 disposed on an inner surface thereof. The circumferential locking portion 245 may be provided protrudingly from the radially inner surface of the bobbin 24 and configured to engage with the driving member 30 to lock the driving member 30 and the bobbin 24 together.

In some embodiments, upon the switching-on operation of the switching apparatus (i.e., upon switching from the open state to the closed state), after the driving member 30 and the bobbin 24 disengage from each other, the bobbin 24 releases the constraint on the driving member 30 and the driving member may rotate (e.g., via the action of the push rod 26). After the driving member 30 rotates, the circumferential locking portion 245 engages the driving member 30 to lock the driving member 30 and the bobbin 24 together. Similarly, upon the switching-off operation of the switching apparatus (i.e., upon switching from the closed state to the open state), when the push rod 26 moves to a predetermined position, the push rod 26 may exert a circumferential component of force on the driving member 30 to cause the driving member to rotate in an opposite direction, and the circumferential locking portion 245 is disengaged from the driving member 30 by rotation of the driving member 30 in the opposite direction. Under continued action of the circumferential component of force of the push rod 26, the driving member 30 is moved into the guide groove of the bobbin 24 to allow the driving member 30 to move rectilinearly along the bobbin 24 (e.g., under the action of a return spring). Thereby, the unlocking of the closed state of the switching apparatus may be achieved and the switching apparatus is allowed to return to the open state.

In some embodiments, as shown in FIG. 5, the circumferential locking portion 245 comprises a circumferential stop ramp 247 extending obliquely in a predetermined direction in the circumferential direction and a circumferential rotation-stopping surface 243 extending along the longitudinal axis. The circumferential stop ramps 247 may be configured to engage a corresponding portion of the driving member 30 to guide the driving member 30 to move circumferentially. In this case, a smooth circumferential movement of the driving member 30 may be permitted. The circumferential rotation-stopping surface 243 may comprise a stop surface extending along the longitudinal axis, and the stop surface may be locked with the driving member 30 to prevent any movement of the driving member 30 in a predetermined rotational direction.

FIG. 6 shows a perspective view of a push rod of a movable contact driving device according to an embodiment of the present disclosure. As shown in FIG. 6, the push rod 26 may be generally cylindrical in shape. The push rod 26 may comprise an axially-extending first engagement portion 263 at one end of the longitudinal axis. The first engagement portion 263 is engageable with the movable core 22 (see FIG. 2) for force transmission. The push rod 26 may comprise an axially-extending second engagement portion 265 at the other end of the longitudinal axis. The second engagement portion 265 is engageable with the driving member 30 (see FIG. 2) for force transmission. The pushrod 26 may further comprise a plurality of circumferentially distributed toothed guide rails 262 engageable with the inner surface of the bobbin 24 to guide the push rod to move rectilinearly.

In some embodiments, as shown in FIG. 6, the push rod 26 comprises a circumferential force-applying portion 264 at an end face at a side facing the driving member 30. The circumferential force-applying portion 264 is configured to apply a circumferential force component to the push rod 26 to rotate the driving member 30. In some embodiments, as shown in FIG. 6, the circumferential force-applying portion 264 comprises a plurality of first inclined portions inclined in a predetermined direction along the longitudinal axis, the plurality of first inclined portions being circumferentially distributed on the end face of the push rod 26 around the longitudinal axis. In the illustrated embodiment, the first inclined portions have a shape of an inclined surface. It should be understood that this is merely exemplary and that the first angled portions may have other shapes as long as they can provide a circumferential force component for driving the driving member 30 to rotate.

FIG. 7 shows a perspective view of a driving member 30 of a movable contact driving apparatus according to an embodiment of the present disclosure. In some embodiments, as shown in FIG. 7, the driving member 30 is generally cylindrical in shape. The driving member 30 may comprise an aperture 37 disposed at one end. The aperture 37 is for example engageable with the second engagement portion 265 of the push rod 26. It should be understood that this is merely exemplary. The aperture 37 may be embodied in other forms as long as it can engage with the push rod 26.

In some embodiments, as shown in FIG. 7, the driving member 30 further comprises a plurality of guide rails 36 evenly distributed in the circumferential direction. The guide rails 36 are engageable with corresponding guide grooves on the bobbin 24 to guide the driving member 30 to make rectilinear movement along a predetermined length.

In some embodiments, as shown in FIG. 7, the driving member 30 also comprises a plurality of circumferential force-receiving portions 34 on an end face facing the push rod 26 which match the circumferential force-applying portions 264. The circumferential force-receiving portions 34 are configured to interact with the circumferential force-applying portions 264 to provide a circumferential force component for rotating the driving member 30. In particular, after the guide rails 36 of the driving member 30 are disengaged from the corresponding guide grooves on the bobbin 24, the driving member 30 can be rotated by the action of the circumferential force component received by the circumferential force-receiving portions 34.

In some embodiments, as shown in FIG. 7, the driving member 30 comprises a stop portion 35 on an end face at a side facing the push rod 26. The stop portion 35 may be configured to engage with a corresponding portion of the bobbin 24 to lock the driving member 30. With the driving member 30 locked, the contact carrier 10 is locked against movement. With the driving member 30 unlocked, the contact carrier 10 is allowed to move. In some embodiments, as shown in FIG. 7, the stop portion 35 comprises an inclined ramp configured to engage circumferential locking portion 245. As shown in FIG. 7, the apex 33 of the inclined ramp may act as a stop point for the open position. At this position, the apex 33 of the driving member 30 snap-fits with the bobbin 24 and cannot move; in turn, the movable contact maintains reliable contact with the stationary contact. It should be understood that the illustrated shape of the stop portion 35 is merely exemplary and that the stop portion 35 may be formed in any other suitable shape.

In some embodiments, as shown in FIG. 7, the driving member 30 further comprises an open position limiting portion 38 disposed a predetermined distance away from the stop portion 35 along the longitudinal axis. During return of the driving member 30 towards the push rod 26 (i.e., during switching from switching-on to switching-off after the driving member 30 is unlocked, e.g., by the action of a return spring), the open position limiting portion 38 contacts the circumferential locking portion 245 to prevent the driving member 30 from continuing to move rectilinearly. Continued upward movement of the driving member 30 may be prevented by the engagement of the open position limiting portion 38 with a fixed member (e.g., the bobbin) of the movable contact driving device.

In some embodiments, as shown in FIG. 7, the open position limiting portion 38 is a circumferential flange projecting radially from the driving member 30. Continued upward movement of the driving member 30 may be limited in a way that the open position limiting portion 38 of the driving member 30 contacts with a corresponding position of the bobbin 24. Therefore, an upper movement limit point of the open position may be formed by the open position limiting portion 38. It should be understood that this is merely exemplary and that the open position limiting portion 38 may be formed in any other suitable shape so long as the corresponding position of the bobbin may contact or abut against the open position limiting portion 38 to limit the upward movement of the driving member 30.

In some embodiments, the movable contact driving device may further comprise a return device. The return device may be configured to return the contact carrier 10 and the driving member 30 to an initial position (i.e., the open position). In some embodiments, the return device may comprise one or more springs 60. The spring may be arranged at a proper position such that the spring is compressed for energy storage when the driving member 30 and the contact carrier 10 move towards the stationary contact. Furthermore, the driving member 30 returns to the initial open position under the action of the return spring when the driving member 30 is unlocked from the bobbin 24. In some embodiments, the spring 60 may comprise a first spring for returning the push rod 26 and a second spring for returning the contact carrier 10 (along with the driving member 30).

In some embodiments, the movable contact driving device may be remotely controlled. To this end, the movable contact driving device further comprises a controller. The controller is configured to receive a switching-off and/or switching-on command, and to issue a command to energize the coil in response to the received switching-off and/or switching-on command. After the coil is energized, the push rod 26 is moved by a movable magnet downwardly along the longitudinal axis.

In some embodiments, the movable contact driving device may be manually controlled. To this end, the movable contact driving device further comprises a manual button 120 that may be mounted to the movable core 22. The manual button 120 may be disposed along the longitudinal axis and may be manually depressed to manually drive the movable core 22 to move rectilinearly along the longitudinal axis, thereby causing the push rod 26 to move along the longitudinal axis to effect respective switching-off and switching-on operations. In other embodiments, the manual button 120 may be mounted to the push rod 26.

FIG. 8 illustrates a perspective view of a contact carrier of a movable contact driving device according to an embodiment of the present disclosure. The contact carrier 10 is configured to carry the movable contact. The contact carrier 10 may be driven by the driving member 30 to move rectilinearly. When the contact carrier 10 is at a first position, the movable contact on the contact carrier 10 may contact with the stationary contact in the switching apparatus to achieve switching-on. When the contact carrier 10 is at a second position, the movable contact on the contact carrier 10 is separated from the stationary contact in the switching apparatus by a predetermined gap to achieve switching-off.

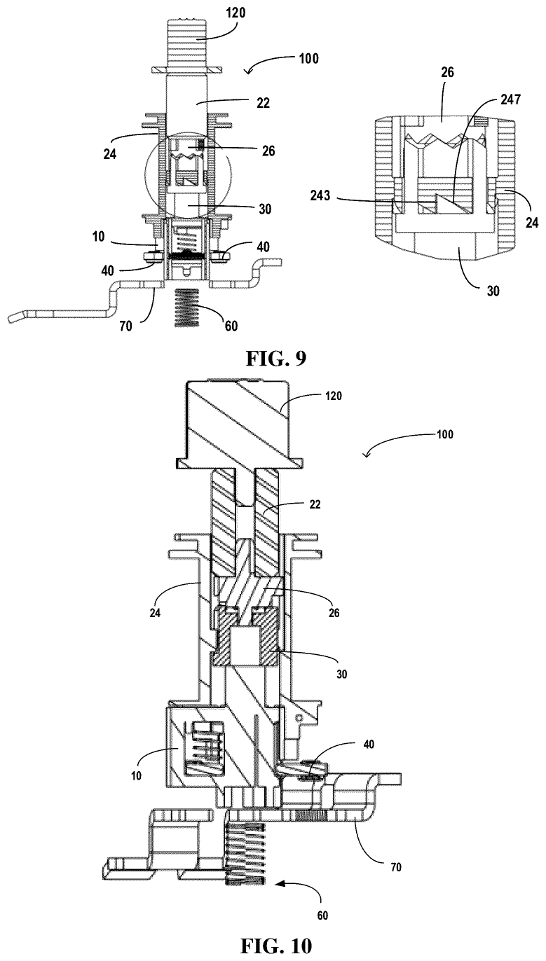

The contact carrier 10 may be coupled to the driving member 30 at an axial end. As an example, the contact carrier 10 may comprise a shaft mounting portion 15. Accordingly, the driving member 30 may include a mounting hole 37 (see FIG. 7). The shaft mounting portion 15 is coupleable with the mounting hole 37 of the driving member 30. It should be understood that this is merely exemplary. Furthermore, in order to ensure the rectilinear movement of the contact carrier 10, the contact carrier 10 may further comprise a guide groove and/or guide rail 13. The guide groove and/or guide rail can cooperate with a corresponding guide member in the frame in the switching apparatus to ensure that the contact carrier moves rectilinearly. In some embodiments, the contact carrier may further include a movable contact over-travel adjustment device (e.g., a spring 17 as shown in FIG. 9), and the fastening position of the movable contact may be adjusted by the spring 17, thereby adjusting the magnitude of a contact force between the movable contact and the stationary contact.

An operation process of the movable contact driving device according to the embodiment of the present disclosure will be described in detail with reference to FIG. 2 and FIGS. 9-12.

As shown in FIG. 9, the switching apparatus is in the open state, and a partially enlarged view of a circled portion is shown on the right side of FIG. 9. As can be seen from the figure, the contact carrier 10 is at the upper position. The movable contact 40 disposed on the contact carrier 10 is spaced apart from the stationary contact 70 by a gap to physically interrupt the circuit. In the state shown in FIG. 9, the driving member 30 abuts against the bobbin 24 under the action of the return spring, whereby the movable contact is maintained in the open state. In the embodiment shown in FIG. 9, the open position limiting portion 38 (i.e., the circumferential flange) of the driving member 30 abuts against a corresponding portion of the bobbin 24. In the illustrated embodiment, the corresponding portion of the bobbin 24 may be a portion on the lowermost side of the circumferential lock portion of the bobbin 24, for example, the topmost end 249 of the circumferential stop ramp 247. According to the movable contact driving device of the embodiment of the present disclosure, it is not necessary to energize the coil to maintain the open state of the switching apparatus.

FIG. 10 shows a sectional view of a switching apparatus in the open state from another angle. FIG. 10 shows structural details of the contact carrier 10, the driving member 30, the push rod 26, the bobbin 24, the movable core 22, and the manual button 120 of the movable contact driving device. As shown in FIG. 10, the contact carrier 10, the driving member 30, the push rod 26, the movable core 22, and the manual button 120, which are sequentially arranged along the longitudinal axis, are maintained at a predetermined open position under the action of the return spring.

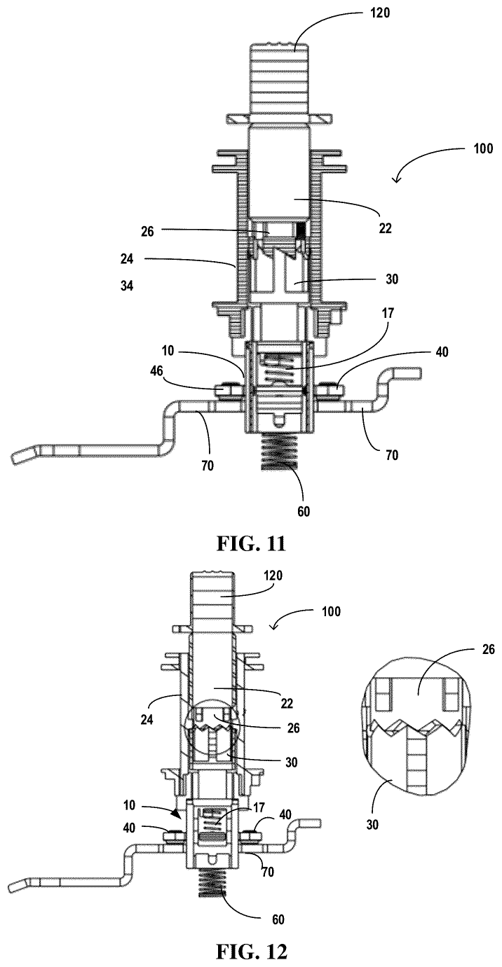

From the state shown in FIG. 9 and FIG. 10, when the coil is energized, the movable core 22 moves the push rod 26 rectilinearly downward, and the push rod 26 presses the driving member 30 rectilinearly downward. Since the driving member 30 and the bobbin 24 move rectilinearly via the engagement of the guide rails and the guide grooves, after the driving member 30 and the bobbin 24 move to a predetermined distance, the driving member 30 is disengaged from the guide rails of the bobbin 24. After the disengagement, as the push rod 26 continues to move downward, since the push rod 26 and the driving member 30 interact with each other, the push rod 26 provides a circumferential force component to the driving member 30, e.g., via a ramp. Under the action of this circumferential force component, circumferential rotation is generated while the driving member 30 moves downward. By the circumferential rotation of the driving member 30, the driving member 30 starts to cooperate with the bobbin and is locked together with the bobbin after rotating by a predetermined angle. The locking position is defined by a corresponding locking point (e.g., a circumferential rotation-stopping surface) of the bobbin. At this time, the switching apparatus is in the closed state shown in FIG. 2 and FIG. 11.

As shown in FIG. 2 and FIG. 11, after the driving member 30 circumferentially rotates by a predetermined angle, the driving member 30 begins to engage with the circumferential locking portion 245 of the bobbin 24 to lock the driving member 30 and the bobbin 24 together. Especially, the circumferential stop ramp 247 of the circumferential locking portion 245 may first contact a top end face of the driving member 30 to guide the circumferential movement of the driving member 30. As the driving member 30 circumferentially moves, the driving member 30 finally engages with the circumferential rotation-stopping surface 243 and cannot circumferentially move any more. In this case, the driving member 30 may be maintained in the closed state through the interaction of the driving member 30 and the bobbin 24. According to the movable contact driving device of the embodiment of the present disclosure, the closed state of the switching apparatus is conveniently maintained without need to energize the coil.

A switching-off process is similar to the switching-on process. From the state shown in FIG. 2 and FIG. 11, when the coil is energized, the movable core 22 moves the push rod 26 rectilinearly downward. When the push rod 26 moves to the position of the open position limiting portion 38, due to the interaction of the mating surfaces of the push rod 26 and the driving rod 30, the driving rod 30 circumferential rotates as it rectilinearly moves. The driving rod 30 is unlocked from the bobbin 24 under the action of the circumferential rotation.

FIG. 12 shows a state in which the driving rod 30 is about to move upward after the driving rod 30 is unlocked from the bobbin 24. The right of FIG. 12 shows a partially-enlarged view of the circled portion of the figure. As the driving rod 30 circumferentially moves, the guide rails of the bobbin 24 re-engage with the guide grooves of the driving rod. At this time, when the coil is de-energized, the push rod 26 returns to its original position under the action of the push rod return spring, and meanwhile, the contact return spring urges the contact and the driving rod to move upward, whereby the movable contact and the stationary contact are separated. The speed at which the contact carrier 10 and the drive rod 30 move upwards may be adjusted by adjusting parameters of the contact return spring. As the driving rod 30 continues to move up and down, the driving rod 30 is maintained at the open position when the driving rod 30 contacts with the bobbin 24 again.

The operating principles of automatic switching on/off of the movable contact driving device are described above. Similar to the operation process of manual switching on/off, the difference from the automatic operation only lies in whether the movement of the push rod is driven automatically via the movable core or operated manually via the push button. For manual switching on/off, the user only needs to manually operate the push button 120 to achieve the switching-off and switching-on operations of the switching apparatus.

According to the movable contact driving device of the embodiment of the present disclosure, manual and automatic control of the movable contact may be achieved by using a set of mechanisms. In addition, since the movable contact driving device achieves the maintenance of the switching-off and closed states in a mechanical manner, the coil does not need to be energized, and energy consumption may be reduced. In addition, the driving mechanism of the movable contact driving device is simple and compact, and convenient to implement.

In addition, while operations are depicted in a particular order, this should not be understood as requiring that such operations are performed in the particular order shown or in sequential order, or that all illustrated operations are performed to achieve the desired results. In certain circumstances, multitasking and parallel processing may be advantageous. Likewise, while several specific implementation details are contained in the above discussions, these should not be construed as limitations on the scope of the subject matter described herein, but rather as descriptions of features that may be specific to particular implementations. Certain features that are described in the context of separate implementations may also be implemented in combination in a single implementation. Rather, various features described in a single implementation may also be implemented in multiple implementations separately or in any suitable sub-combination.

Although the subject matter has been described in language specific to structural features and/or methodological acts, it is to be understood that the subject matter specified in the appended claims is not necessarily limited to the specific features or acts described above. Rather, the specific features and acts described above are disclosed as example forms of implementing the claims.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A movable contact driving device, comprising:
a contact carrier configured to carry a movable contact;
an electromagnetic actuator comprising: a coil; a movable core movable along a longitudinal axis in a state in which the coil is energized; and a push rod engaged with the movable core and driven by the movable core to move along the longitudinal axis; and
a driving member disposed along the longitudinal axis between the push rod and the contact carrier and configured to be driven by the push rod to move the contact carrier along the longitudinal axis,
wherein the driving member is configured to, when the push rod moves to a first predetermined position along the longitudinal axis, rotate relative to the push rod in a first direction such that the driving member engages a fixed portion of the electromagnetic actuator to lock the contact carrier in a position corresponding to a closed position of the movable contact; and, when the push rod moves to a second predetermined position along the longitudinal axis, rotate relative to the push rod in a second direction opposite the first direction such that the driving member is unlocked from the fixed portion of the electromagnetic actuator to allow the contact carrier to move to a position corresponding to an open position of the movable contact.

2. The movable contact driving device according to claim 1, wherein the electromagnetic actuator further comprise a bobbin serving as the fixed portion and for winding the coil, the bobbin comprises a cavity extending along the longitudinal axis, and the movable core and the driving member are at least partially disposed within the cavity.

3. The movable contact driving device according to claim 2, wherein one of an inner surface of the bobbin and an outer surface of the push rod comprises a radially-protruding first guide rail, and the other of the inner surface of the bobbin and the outer surface of the push rod comprises a radially-recessed first guide groove, wherein the first guide groove cooperates with the first guide rail such that the push rod moves rectilinearly.

4. The movable contact driving device according to claim 2, wherein one of the inner surface of the bobbin and an outer surface of the driving member comprises a radially-protruding second guide rail, and the other of the inner surface of the bobbin and the outer surface of the driving member comprises a radially-recessed second guide groove cooperating with the second guide rail, wherein when the push rod moves to the first predetermined position along the longitudinal axis, the driving member slides rectilinearly relative to the bobbin, and is rotatable relative to the push rod after the second guide rail and the second guide groove are disengaged.

5. The movable contact driving device according to claim 2, wherein the push rod comprise a circumferential force-applying portion at an end face at a side facing the driving member, the circumferential force-applying portion being configured to be capable of applying a circumferential force component to the push rod to rotate the driving member.

6. The movable contact driving device according to claim 5, wherein the circumferential force-applying portion comprises a plurality of first inclined portions inclined along the longitudinal axis, the plurality of first inclined portions being circumferentially distributed on the end face of the push rod around the longitudinal axis.

7. The movable contact driving device according to claim 5, wherein the driving member comprise a plurality of circumferential force-receiving portions on an end face facing the push rod which match the circumferential force-applying portions, the circumferential force-receiving portions being configured to:
when the push rod moves to the first predetermined position along the longitudinal axis, interact with the circumferential force-applying portions to provide a circumferential force component for rotating the driving member in the first direction;
when the push rod moves to the second predetermined position along the longitudinal axis, interact with the circumferential force-applying portions to provide a circumferential force component for rotating the driving member in the second direction.

8. The movable contact driving device according to claim 5, wherein the bobbin furthers comprise a circumferential locking portion protruding on an inner surface thereof, the circumferential locking portion being configured to engage with the driving member to lock the driving member and the bobbin together.

9. The movable contact driving device according to claim 8, wherein the circumferential locking portion comprises a circumferential stop ramp extending obliquely in a circumferential direction and a circumferential rotation-stopping surface extending along the longitudinal axis, and the circumferential stop ramp and the circumferential rotation-stopping surface are configured to interact with the driving member at different positions in the circumferential direction.

10. The movable contact driving device according to claim 8, wherein the driving member comprise a stop portion on an end face at a side facing the push rod, and the stop portion comprises an inclined ramp configured to engage circumferential locking portion.

11. The movable contact driving device according to claim 10, wherein the driving member further comprises an open position limiting portion disposed a predetermined distance away from the stop portion along the longitudinal axis, wherein during return of the driving member towards the push rod, the open position limiting portion contacts the circumferential locking portion to prevent the driving member from continuing to move rectilinearly.

12. The movable contact driving device according to claim 11, wherein the open position limiting portion is a circumferential flange projecting radially from the driving member.

13. The movable contact driving device according to claim 1, further comprising a return spring configured to at least engage the contact carrier, the return spring configured to return the contact carrier and the driving member to an initial position after the coil for moving the movable core is de-energized.

14. The movable contact driving device according to claim 1, further comprising a controller configured to receive a switching-off and/or switching-on command, and to issue a command to energize the coil in response to the received switching-off and/or switching-on command, so that the push rod moves along the longitudinal axis.

15. The movable contact driving device according to claim 1, further comprising a manual button configured to be mounted to the movable core and/or the push rod, wherein depression of the manual button causes the push rod to move along the longitudinal axis.

16. A switching apparatus, comprising:
a stationary contact;
a movable contact; and
the movable contact driving device according to claim 1.

17. The switching apparatus according to claim 16, wherein the switching apparatus is a circuit breaker, a disconnecting switch or a contactor.
